(19) United States
(12) Patent Application Publication
(10) Pub. No.: US 2013/0113792 A1
(43) Pub. Date: May 9, 2013

(54) Three Dimensional Computer Graphics System

(71) Applicant: Imagination Technologies Limited, Kings Langley (GB)

(72) Inventor: Morrie Berglas, Kings Langley (GB)

(73) Assignee: IMAGINATION TECHNOLOGIES LIMITED, Kings Langley (GB)

(21) Appl. No.: 13/725,424

(22) Filed: Dec. 21, 2012

Related U.S. Application Data
(63) Continuation of application No. 11/725,354, filed on Mar. 19, 2007, now abandoned.
Application No. 11/725,354 is a continuation of application No. 11/188,259, filed on Jul. 22, 2005, now abandoned.
Application No. 11/188,259 is a continuation of application No. 10/310,120, filed on Dec. 4, 2002, now abandoned.

(30) Foreign Application Priority Data
Dec. 14, 2001 (GB) 0129966.8

(51) Int. Cl. G06T 15/04

(52) U.S. Cl. CPC G06T 15/04
USPC 345/419

(57) ABSTRACT

A blend buffer has a pre-determined plurality of locations, each with a set of registers. The locations are allocatable to pixels. The blend buffer has a first write port and a second write port. The first write port couples with a texture read unit and the second write port couples with a blending unit. The blending unit also interfaces with a read port of the blend buffer. The texture unit receives texture coordinates from a texture coordinate calculator. The blending unit is operable to interface with the texture coordinate calculator. The blending unit is operable to perform write only transactions of pixel data to locations of a render target that corresponds to respective locations in the blend buffer, once after completion of processing the pixels for which data is being written.

### CROSS-REFERENCE TO RELATED APPLICATION

This application is a continuation of Ser. No. 11/725,354, filed on Mar. 19. 2007, which was a continuation of Ser. No. 11/188159, filed on Jul. 22, 2005, abandoned, which was a continuation of Ser. No. 10/310,120, filed on Dec. 4, 2002, abandoned, these applications are entirely incorporated by reference for all purposes.

### FIELD OF THE INVENTION

This invention relates to 3-dimensional computer graphic systems which enable texturing and/or blending operations to be performed on objects being rendered.

### BACKGROUND OF THE INVENTION

An example of a 3-dimensional graphic system is described in our European patent application serial number EP-A-072 5365. This describes an apparatus and a method for determining which surfaces of objects in an image to be rendered are visible at each pixel in the image.

Following determination of the objects visible at each pixel, texture data may be applied to the pixels. An example of how this is done is described in our British patent application number 9501832.1. This describes a texturing system in which an image to be textured is sub-divided into a plurality of rectangular tiles. Then, for each tile in turn, texturing of the pixels in the tile is performed. Also, blending operations can be performed with translucent surfaces.

A type of system to which this form of texturing applies is shown in FIG. 1. This comprises a texture iteration unit 2 which determines the textures and polygons within a frame or a tile of the frame which are to be applied to the pixels in that frame or tile. The texture read unit 4 retrieves relevant texture data from a texture cache 6 and passes this to a blending unit 8. This takes the pixels from a frame buffer 10, modifies them by applying the texture in a blending operation, and writes them back to the frame buffer. The reading from the frame buffer may be via an optional cache memory 12 which may contain only a single tile of frame buffer data at a time.

The process performed by this prior art system is usually performed in two main ways as shown in FIGS. 2A and 2B. FIG. 2A shows what is known as polygon walking whilst FIG. 2B shows an alternative way.

Polygon walking refers to a system where the pixels for a single texture and/or the blending operation are walked through sequentially before proceeding to subsequent textures or the blending operations for those pixels or a subset of those pixels. The flow of this operation is illustrated in FIG. 2A. Two parameters are used. “a” is the number of texturing or the blending operations to be performed and “b” is the number of pixels to be walked through. Initially, “a” and “b” are set to 0 at step 14. The first in the operation list is then applied to pixel “b” at step 16, and a determination as to whether or not this is the last pixel to which the operation is to be applied is determined at step 18. If it is not, the pixel “b” is incremented at step 20, and the flow returns to step 16 where the operation “a” is performed on a new pixel “b”. When the last pixel is reached, a determination is made at step 22 as to whether or not the last operation in the list “a” has been performed. If it has not, the operation “a” is incremented at step 24 and the pixel “b” is reset to 0. The flow then returns to step 16 and continues as described above. When the last operation “a” is reached, the system goes onto the next polygon to be rendered at step 26, and the system returns to step 14 where the operation “a” is set to 0 and the pixel “b” is set to 0.

The main advantage of polygon walking, i.e. processing one polygon at a time, is to reduce processing penalties due to data hazards, such as where a texture reading or the blend operation depends on the result of the previous reading or blending. The larger the sequence of pixels walked through, the more the latency penalty is absorbed. However, on very small polygons with only one pixel, the walking system degenerates into a non-walking system.

A non-walking system is shown in FIG. 2B. Again, this commences at step 14 where parameters “a” and “b” corresponding to operations and pixels are set to 0. At step 16, the first operation “a” is performed on pixel “b”. A determination is then made at step 22 as to whether or not this is the last in the operation list “a”. If it is not, “a” is incremented at step 28 and a new operation “a” is applied to pixel “b” at step 16. This continues until the determination is made at step 22 where the last operation has been performed. At this point, pixel “b” is incremented and operation “a” is reset to 0 at step 30. The flow then returns to step 16 where it continues as described above.

The main advantage of this type of system is that very little storage for intermediate results is required since only one pixel is worked on at a time. In polygon walking where a polygon could be as large as the entire render target, there may need to be sufficient storage for all intermediate results for each pixel in the rendered target.

### SUMMARY OF THE INVENTION

Preferred embodiments of the present invention are based on polygon walking systems. They take advantage of the fact that pixel blending operations in hardware are becoming more and more flexible, thereby allowing storage for multiple, general purpose read/write registers for each pixel in the render target. Furthermore, the precision of these registers increases as the number of available registers and the render target size increase.

These developments cause problems which currently can only be solved by re-issuing texture reading and breaking complex blending operations into sequential passes. Both of these result in a loss of performance. There are also problems caused by pipeline latency on texture reading or blending operations which are dependent on the results of the previous operations. The cost of storage is also a problem as the buffer or the cache such as shown at step 12 in FIG. 1 is too large to fit on a typical graphic processing chip and leads to a performance penalty because of the limited bandwidth for the “read modify write” process with the cache 12 or the frame buffer 10.

A specific embodiment of the present invention provides a pixel blending buffer on a graphics chip. It enables portions of a frame buffer or a tile from the frame buffer to be accessed on a polygon by polygon basis. Large polygons are broken up so that they never exceed a predetermined size. Smaller polygons can be combined together to fill up the pixel blending buffer thereby improving the performance of the system.

Preferably, the embodiment of the invention enables multiple textures to be accessed simultaneously in a single blending operation. Texture data can be reused, in random order, without re-issuing texture reading requests to texture memory. More textures than the number of physical registers provided on a chip can be supported. These features are implemented by using a set of registers with multiple “read and write” ports which can be used and re-used indefinitely during the process of a sequence of pixels, depending on the number of textures and blending operations to be performed.

### BRIEF DESCRIPTION OF THE DRAWINGS

The specific embodiment of the invention will now be described in detail by way of an example with reference to the accompanying drawings in which:

FIG. 1 is the prior art system described above;

FIGS. 2A and 2B show the polygon walking system and the non-walking system;

FIG. 3 is a block diagram of a preferred embodiment of the invention;

FIG. 4 shows the data structure of words in the blend buffer of FIG. 3;

FIG. 5 graphically shows a trait that covers a part of a tile to be rendered;

FIG. 6 shows how the iteration of the pixels proceeds for three different signal blend buffers; and

FIG. 7 is a clarification of the blend and the texture units of FIG. 3.

### DETAILED DESCRIPTION

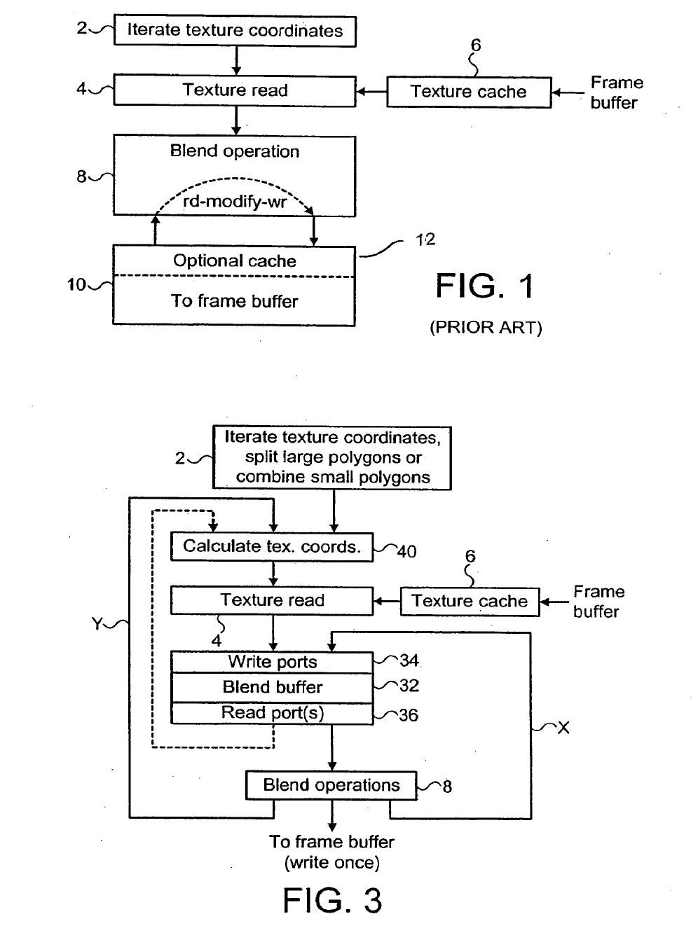

The block diagram of FIG. 3 is a modified version of a standard 3-D pixel pipeline shown in FIG. 1. At the heart of the system is a blend buffer 32 which is accessed via write ports 34 and provides data output via read ports 36.

A texture iteration unit 2 as in FIG. 1 provides texture coordinates to the system. It performs this operation via a further texture calculator unit 40 which receives data in a feedback loop from the blend operations unit 8.

The blend buffer 32 with read and write ports sits between the texture read unit 4 and the blend operations unit 8. By using the blend buffer 32, the blend operation unit 8 needs not perform a “read-modify-write” operation on the frame buffer. Thus, the blend operations can be performed as many times as desired on the data held in the blend buffer using feedback loop X which takes data directly from the blend buffer 8 to the write ports 34.

The blend buffer stores a set of words in registers, where each word has a unique sequential address as would be the case with a standard storage array. Each word in the blend buffer stores the following fields:

1. The X, Y location of a pixel in the render target (the frame buffer or a tile of the frame buffer);

2. q, the number of pixels being processed simultaneously by the hardware pipeline; and

3. M, the number of registers each pixel has access to, wherein each register is made up of the following fields:
alpha/Q channel comprising K_{M} bits
red/U channel comprising K_{M} bits
green/V channel comprising K_{M} bits
blue/W channel comprising K_{M} bits.

The value of q given above defines how many pixels are processed simultaneously by the hardware pipeline. The value of M defines the number of registers each pixel has access to. For example, at each register in M, four channels have their own precision defined by K_{M}. A designer can use a value of K_{M} of 8 for read only iterated diffuse operations, and specular colors and values for K_{M} of 16 for general purpose read/write registers.

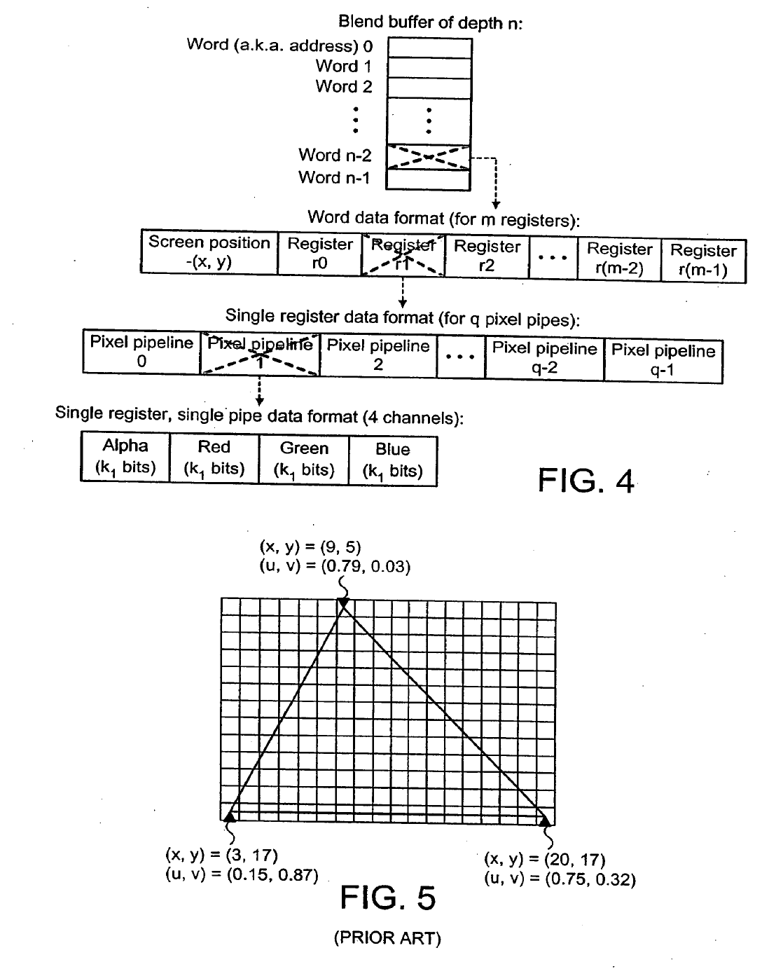

The depth of the blend buffer is defined as n, and this is shown in FIG. 4 with addresses ranging from 0 to n-1. Thus, n is the maximum number of the pixels which can be processed at the same time, although its value is arbitrary and is selected at the hardware design stage. Choosing a larger value of n leads to additional storage being required on the graphics chip. However, a larger value of n increases performance as more pixels can be processed at the same time. A smaller value of n will result in smaller storage on the chip blend buffer, but data hazards will cause performance reduction. The other quantities, m, q and k are fixed by constraints in other parts of the graphics system or by external specifications.

A common optimization is to replicate the hardware for a single pixel pipeline and run the pipelines in parallel. Thus multiple pixels perform steps 16, 18, and 20 per clock, but all these pixels still share the same index b. The number of the parallel pixel pipelines is defined as the value q in FIG. 4.

Since q pixels share the same index b, they also share the same word in the blend buffer. This is why each address in the blend buffer supports q sets of the pixel data, as shown in FIG. 4.

FIG. 4 shows that the data bus width of the blend buffer is expressed as (let sps be the number of bits required to encode the (x, y) screen position):

$$sps + m χ {\sum }_{i = 0}^{q - 1} 4 {k}_{i}$$

In FIG. 3, the read and write ports have access to the blend buffer shown in FIG. 4. The blend buffer supports read/write enables and read/write addresses for an individual register so that multiple ports can use the blend buffer without arbitration if they are accessing different registers.

If two write ports wish to update the same register at different addresses, then arbitration is required. In this design the texture lookup unit always has “write” priority over the texture blending unit. Since this proposal only has a single read port, no read arbitration is required. When a read access is performed for address b, the read word contains the data for all parallel pipes which allows simultaneous execution of the parallel pipelines.

Typically, the value of n will be less than the render target size. For example, the render target might be a tile of 64×64 pixels with n being a total of 64 words. Larger polygons will have pixel sequences which require more than n words to process them. This will be the case with large polygons which need to be broken into smaller sequences equal to or less than n. Although there is a performance cost associated with splitting a sequence, this will happen only on relatively long sequences. This splitting of large polygons is performed by the texture iteration unit 2 of FIG. 3. An iteration in 3-D graphics pipelines is a process where data such as (u, V) texture coordinates for three vertices of a triangle is used, in conjunction with three (x, y) screen coordinates of the three vertices, to determine (u, v) values for each pixel covered by that triangle. This is shown in FIG. 5.

In the polygon-walking method used by this design the iterator goes through the pixels in a defined order and linearly interpolates the (u, v) values for each pixel sequentially, e.g., linearly interpolates proper (u, v) values for all pixels contained by the triangle such as the one pointed to by reference numeral 5 where (x, y)=(13, 14). If there are multiple parallel pixel pipelines, then multiple (u, v) values for adjacent pixels are iterated per clock.

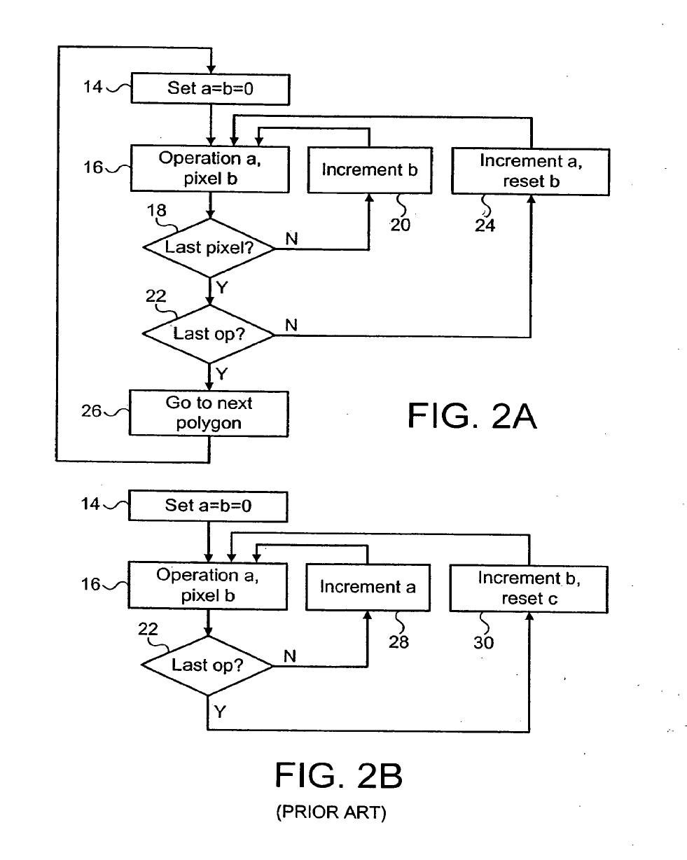

This implementation has an additional ability for the whole triangle to be iterated multiple times (in fact the times as shown in FIG. 2A). In this case the triangle will not only have (x, y) and (u, v) data, but in fact it will support (x, y) and many sets of (u, V) data which can be iterated during sequential passes of the triangle.

As (u, v) data is iterated, the results are used in the texture read unit 4 to sample a texture whose results are written into the blend buffer in sequential addresses, starting from 0 at the beginning of the triangle.

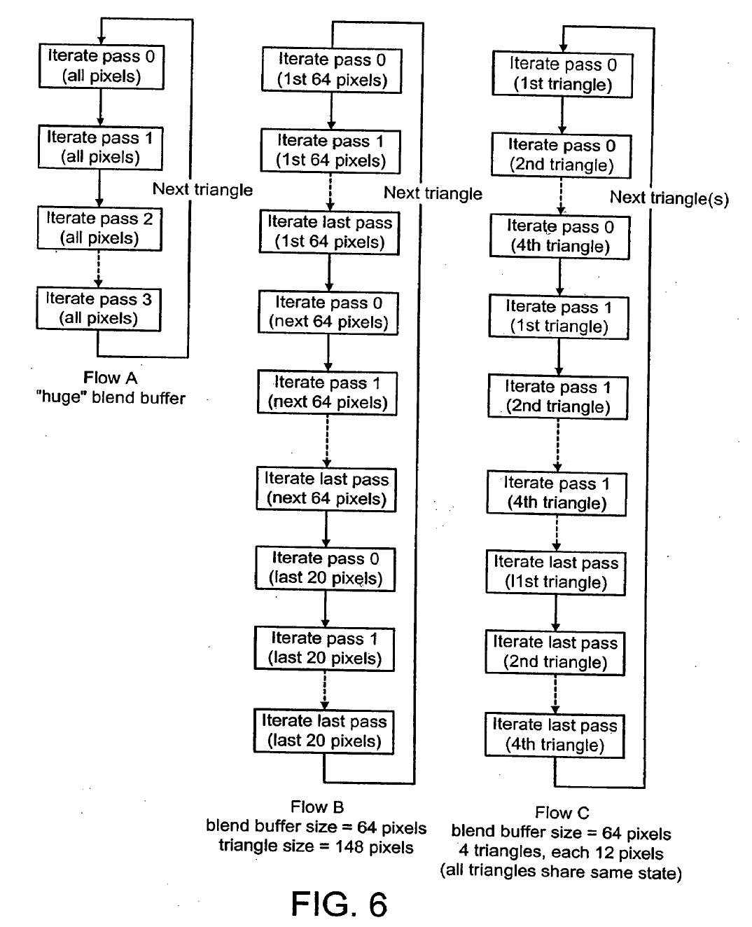

The implementation requires a special processing if the number of pixels in the triangle would cause the blend buffer to overflow when the entire triangle is iterated during a single pass. This is solved as shown in FIG. 6. Flow A of FIG. 6 shows an example of how the processing would operate if the blend buffer is large enough to accommodate the largest triangle. Flow B of FIG. 6 shows what would happen if the blend buffer could hold 64 pixels and the size of the triangle is 148 pixels. Flow C of FIG. 6 shows what would happen if the blend buffer would hold 64 pixels and there are 4 triangles of which the size of each triangle is 12 pixels which share the same state.

In FIG. 3, once texture coordinates have been iterated, and large polygons are split or small polygons are combined, the required texture coordinates are calculated at step 40 and then read from the texture cache 6 by a texture read unit 4 in the same manner as shown in FIG. 1.

The texture coordinate calculation unit 40 can make modifications to the iterated texture coordinates produced by the iterator unit 28. In the general case, no modification is made, and the texture coordinates are used exactly as iterated. However, the end user has control over some modifications to the texture coordinates prior to (or even instead of) texture reads. This modification is sometimes called perturbation.

The texture is then supplied to the blend buffer 32 via the write ports 34. The blend buffer and the blend operation unit 8 then perform the polygon walking described in relation to FIG. 2A for all the pixels ranging from 0 to N stored in the blend buffer for the current set of the textures via feedback loop X. Once all the operations have been performed for all of the polygons relevant to the pixels currently stored in the blend buffer, the current contents of the pixel data in the blend buffer are written to the frame buffer 10 in a single operation. The addresses to which the data is written are dependent on the X, Y location data stored in the blend buffer. It will be appreciated that the X, Y locations stored in each word from 0 to n-1 are not necessarily sequential. It will usually be the case that they are sequential where a large polygon has been broken up for processing. However, when smaller polygons are being combined and processed simultaneously, the addresses will not be sequential. Thus the writing into the frame buffer is a random writing. It is a write-once-operation, and not a multiple read-modify-write processor shown in FIG. 1. The next set of the pixels and the textures are then sent into the blend buffer with the feedback loop X. Once all the operations for a polygon (a triangle) are complete and the texture pixel data has been written to the frame buffer, the contents of the blending buffer are reset or invalidated. The polygon then begins to be textured with a cleared blend buffer as it starts to fill up via the texture read unit 4 of FIG. 3. The process of invalidating the blend buffer is accomplished by negating all the valid flags located in the control unit. The negating valid flags for the registers in the blend buffer occurs during the last blend operation “a” which accesses the register by a read port 36. Therefore, by the time the very last blend operation “a” is complete, all the valid flags will be negated, indicating that the blend buffer is cleared for a new polygon or triangle.

When the value of n is sensibly chosen, the blend buffer 32 can be provided on a graphics chip thereby giving significant performance gains. In case the blending operations require multiple register for “read” and “write”, they do not have to access the relatively slow external frame buffer, which is far too large to store on chip, even when a cache 12 shown in FIG. 1 is used to store the contents of the particular tile currently under consideration.

The read and write ports 34 and 36 in FIG. 3 include a hardware semaphore mechanism as a separate, contained control unit. The semaphore solves three problems. First, the write ports of the semaphore block (a.k.a. stall) try to overwrite valid data located inside the blend buffer. Second, the read ports of the semaphore block try to read invalid data from the buffer. Third, the write ports of the semaphore blocks try to write to a register for which they do not have write-ownership.

All this is accomplished with the two flag-sets in the semaphore unit: a set of valid flags and a set of write-ownership flags. For a system with two write ports (one from texture read and the other from the blending unit) and one read port from the blending unit, there is one valid flag associated with each register and with each word in the blend buffer. For example, a blend buffer with 32 locations, each with six registers would have 32×6 (192) flags. There is only one write-ownership flag per register, so in the previous example there would be only six write-ownership flags.

Each flag has a set condition and a clear condition. In some cases these conditions are based on the operation, as described by the end user, currently being performed. In other words the system relies partially on the end user to determine when the flags are to toggle:

“Valid set” is toggled when a successful write access occurs to the given register at the given blend buffer write address;

“valid clear” is toggled for the given blend buffer read address and for each read register, after a successful read access occurs if the current operation (defined by the end user) indicates that the valid flag should be cleared;

“Write-ownership flag” is toggled when the last successful write access to a register occurs for an operation in the triangle. (The write-ownership is swapped if the end user indicates that it should be swapped for this operation);

“Write port block” is toggled when writing to a register of which valid bit is set for the current blend buffer write address or when writing to a register and write-ownership is not granted; and

“read port block” is toggled when reading a register of which valid bit is not set for the current blend buffer read address.

With the two resources, the valid flags and the write-ownership flags defined above, it becomes easier to implement the three semaphore mechanisms.

A secondary usage of the semaphore unit permits the texture read unit 4 and the blending unit to write and rewrite registers (i.e., reuse registers), which is an exceptionally useful feature. For example:

Texture read unit writes r0;

Blending unit uses r0 in a calculation;

Texture unit writes to r0 again; and

Blending unit uses new r0 in a calculation.

In the above example the texture unit writes to r0 twice.

The above implementation can be extended to support the multiple read ports in addition to the multiple write ports. To handle the multiple read ports, each port needs its own set of the valid flags. The condition to set the flags applies to all the read ports, but each read port individually controls when the flags are cleared by the end user. The flag for the write port will be stalled if any of the valid flags of the read port is still set for the given register and the write address.

The purpose of these flags is to control the number of the texture reads that have to be performed. This does not have to be equal to the number of the blending operations. Nevertheless, the number of the pixels in a polygon must remain the same for all the texture reads and for all the blending operations in that polygon.

The example of FIG. 3 shows the blend buffer 32 that has two write ports 34 and two read ports 36. In alternative implementations, the multiple write ports can come from the results of the blending operations performed at step 8. This would enable the processing of the multiple blending operations simultaneously without walking through pixels one at a time as is the case with a system corresponding to FIG. 2A. This would lead to improvements in performance. Thus, the division of the multiple read and write ports can improve the performance. Similarly, the multiple read and write ports will enable the multiple texture reads to incur simultaneously.

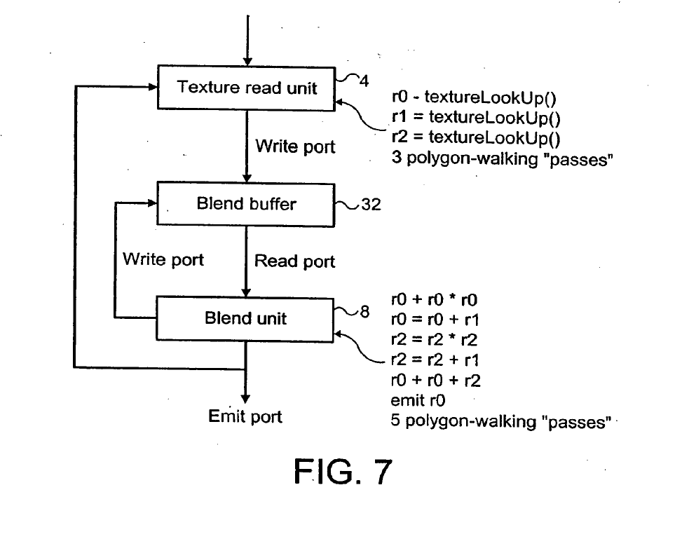

Each unit (the texture read unit and the blend unit) independently “walks the polygon” by the method shown in FIG. 2A. For both units, the number of the operations (i.e., “passes”)“a” may be different as shown in FIG. 7. However, the number of pixels “b” is always exactly the same for both units for the given polygon (or a set of small state-sharing polygons).

I claim:

1. A 3- graphics D system, comprising:
a frame buffer;
a blend buffer, provided in a memory distinct from a memory in which the frame buffer exists, the blend buffer organized to contain a pre-determined number of locations, with each location comprising a set of registers and comprising a first write port, a second write port and at least one read port, wherein locations of the plurality are assigned to pixels of one or more primitives;
a texture read unit coupled for reading from a texture cache and coupled to the first write port of the blend buffer, the texture read unit operable to receive calculated texture coordinates from a texture coordinate calculator, and use the received calculated texture coordinates in reading texture data and providing that texture data for storage in the blend buffer as a current set of textures; and
a blending unit coupled to the second write port of the blend buffer, to the at least one read port of the blend buffer, and to the texture coordinate calculator, the blending unit operable to perform polygon walking for each pixel having a location assigned in the blend buffer, for each texture of the current set of textures, and to write the pixels from the blend buffer to the frame buffer as write-only transactions on the frame buffer.

2. The 3- graphics D system of claim 1, further comprising a hardware semaphore operable to stall write transactions to the blend buffer, from the first write port and the second write port, which would over write valid data in the blend buffer.

3. The 3- graphics D system of claim 2, wherein each register in the set of registers for each location of the blend buffer is associated with a valid flag used by the hardware semaphore to determine validity of data in the blend buffer.

4. The 3- graphics D system of claim 1, wherein each location of the blend buffer is operable to store coordinates of a pixel in a render target to which the data from that location will be written, wherein the coordinates in each location can be non-sequential and the blending unit is operable to perform random writes to non-sequential locations of the frame buffer in order to write the pixels from the blend buffer to the frame buffer.
